(19) United States
(12) Patent Application Publication
(10) Pub. No.: US 2014/0283692 A1
(43) Pub. Date: Sep. 25, 2014

(54) FOOD SPINNER

(71) Applicant: Ki Mee Metal & Plastic Factory Limited, Hongkong (CN)

(72) Inventor: Shun So, Hong Kong (CN)

(21) Appl. No.: 13/849,855

(22) Filed: Mar. 25, 2013

(51) Int. Cl. A47J 43/044

(52) U.S. Cl. CPC A47J 43/044
USPC 99/495

(57) ABSTRACT

A food spinner has a housing including a cover, a basket supported in the housing for rotation, a drive mechanism supported by the cover for rotating the basket, and a brake mechanism supported by the housing for braking the basket and stopping rotation of the basket. The brake mechanism has an operator for manual operation of the brake mechanism, and a braking member movable by the operator from an inoperative position to an operative position directly engaging the basket for braking the basket by friction.

### BACKGROUND OF INVENTION

Food spinners are commonly in the kitchens for quickly spinning off water from food such as salad, vegetable or the like. Most of such spinners are hand-operated. A typical construction includes a bowl-shaped housing, a basket supported in the housing for rotation, and a drive mechanism for rotating the basket to spin off water from food in the basket. Whilst the drive mechanism should be designed to rotate the basket as fast as possible to spin off water quickly, the ability to stop the basket swiftly is another users' concern. It is known to provide a brake for this purpose, most of which seem to work, but there is room for improvement.

The invention seeks to provide a food spinner with a new or otherwise improved brake mechanism.

### SUMMARY OF THE INVENTION

According to the invention, there is provided a food spinner comprising a housing including a cover, a basket supported in the housing for rotation about an axis of rotation, a drive mechanism supported by the cover for rotating the basket to spin off water from food in the basket, and a brake mechanism supported by the housing for braking the basket to stop rotation of the basket. The brake mechanism comprises an operator for manual operation to operate the brake mechanism and a braking member movable by the operator from an inoperative position to an operative position into direct engagement with the basket for braking the basket to stop rotation of the basket by friction.

Preferably, the basket comprises a bottom and a side wall upstanding from the bottom, and the braking member is arranged in the operative position to directly engage the side wall for stopping rotation of the basket.

More preferably, the side wall has a peripheral part, and the braking member is arranged in its operative position to directly engage the peripheral part for stopping rotation of the basket.

Further more preferably, the peripheral part comprises a rim of the basket, the rim being upwardly-facing.

In a preferred embodiment, the brake mechanism includes a brake element to provide additional direct engagement with the basket when the braking member is in its operative position, thereby assisting in braking of the basket.

More preferably, the brake element is provided adjacent the basket for engagement by the basket when the basket is being engaged by the braking member, thereby assisting in braking of the basket.

Further more preferably, the basket is supported loosely in the housing and is arranged to be displaced by the braking member into engagement with the brake element.

It is preferred that the housing includes a support which supports the basket for rotation, and the brake element is provided on at least one side of the support opposite the braking member about the axis of rotation.

It is further preferred that the cover has an inner part which provides the brake element and is operatively in alignment with the basket for engagement with the basket.

In a preferred embodiment, the food spinner includes an abutment provided adjacent the basket for bearing by the basket when the basket is being engaged by the braking member, thereby maintaining the position of the basket during braking of the basket.

More preferably, the housing includes a support which supports the basket for rotation, and the abutment is provided on at least one side of the support opposite the braking member about the axis of rotation.

Further more preferably, the cover has an inner part which provides the abutment and is operatively in alignment with the basket for bearing by the basket.

It is preferred that the inner part of the cover is annular and extends co-axially with the basket about the axis of rotation.

It is preferred further that the inner part comprises an annular rib which extends co-axially with the basket about the axis of rotation.

In a preferred embodiment, the inner part of the cover comprises at least one protrusion which protrudes from an inner surface of the cover.

More preferably, the food spinner includes a plurality of said protrusions, which together with the braking member are located at equiangular positions about the axis of rotation.

In a preferred embodiment, the braking member is movable between an upper inoperative position and a lower operative position, and includes a bifurcate lower end for, in the operative position, engaging the rim of the basket to brake the basket by riding on the rim.

More preferably, the bifurcate lower end has a first prong for bearing upon an outer side or surface of the rim and a relatively shorter second prong for bearing marginally upon an inner side or surface of the rim.

It is preferred that the basket is closable by a lid which fits within the rim of the basket, the lid being operatively in drive engagement with the drive mechanism for rotation by the drive mechanism to in turn rotate the basket.

It is preferred that the basket is closable by a lid which is operatively in drive engagement with the drive mechanism for rotation by the drive mechanism to in turn rotate the basket.

It is preferred that the braking member has an upper inoperative position and a lower operating position, and is resiliently biased towards the inoperative position by means of a spring, against the action of which the operator is to operate the brake mechanism.

It is preferred that the cover has a peripheral portion, at which the brake mechanism is provided.

In a preferred embodiment, the drive mechanism comprises a lever pivotable in opposite first and second directions, a first ratchet rotatable by the lever pivoting in the first direction, a second ratchet rotatable by the lever pivoting in the second direction, and a train of gears arranged to transmit rotational drive from the first and second ratchets in respective opposite first and second directions alternately to the basket, the train of gears including a gear having opposite left and right sides with which the first and second ratchets are in drive transmission respectively such that the gear is driven by the first and second ratchets alternately to rotate in one direction for in turn rotating the basket.

More preferably, the drive mechanism includes an accelerator which is a rotary ratchet device operable in one direction to transmit the rotational drive from the lever when the rotational drive is faster than the basket and to release intermittently when the rotational drive is slower than the basket.

### BRIEF DESCRIPTION OF DRAWINGS

The invention will now be more particularly described, by way of example only, with reference to the accompanying drawings, in which:

FIG. 1 is a top perspective view of an embodiment of a food spinner in accordance with the invention;

FIG. 2 is another top perspective view equivalent to FIG. 1, showing a lever of the food spinner retracted in a recess on the top;

FIGS. 3A to 3C together are an exploded perspective view of the food spinner of FIG. 1;

FIG. 4 is a cross-sectional side view of the food spinner of FIG. 1, showing internal details thereof including a brake mechanism; and

FIG. 5 is a cross-sectional side view equivalent to FIG. 4, showing the brake mechanism in operation.

### DETAILED DESCRIPTION OF PREFERRED EMBODIMENT

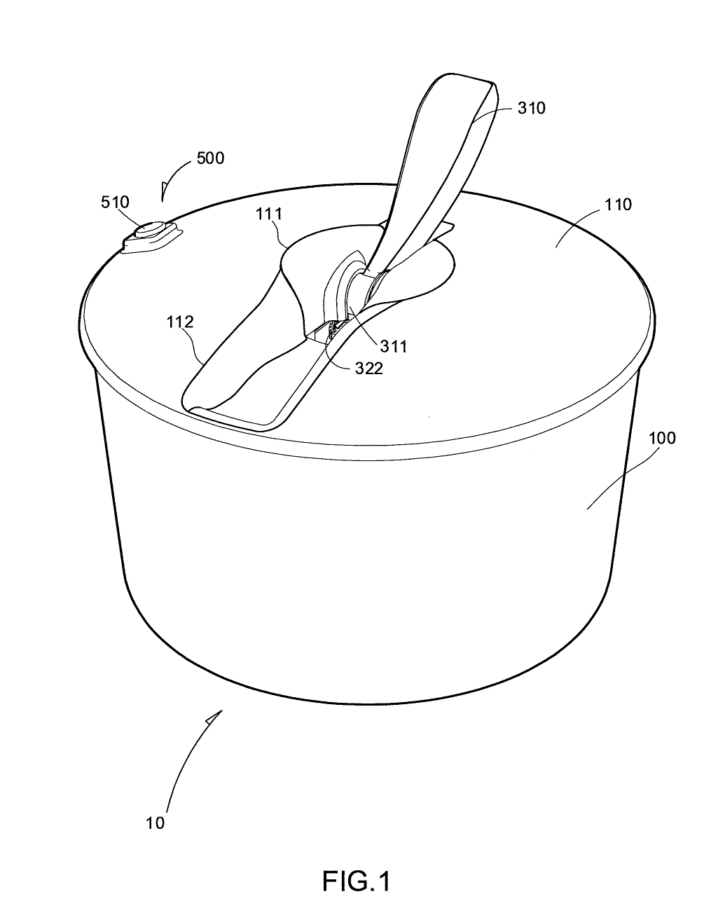

Referring to FIGS. 1 to 5 of the drawings, there is shown a food spinner embodying the invention, which is in the form of a salad spinner 10 for salad or vegetable, etc. The spinner 10 has a bowl-like housing 100 including a circular top cover 110, a round basket 200 located in the housing 100 and supported for rotation about a vertical central axis of rotation X, and a drive mechanism 300 supported by the cover 110 for rotating the basket 200 so as to spin off water from salad or vegetable contained in the basket 200. The basket 200 is in use closed by its own circular lid 210, which couples the basket 200 to be in drive engagement with the drive mechanism 300 for rotation thereby.

The salad spinner 10 includes a brake mechanism 500 which is supported by the housing 100 for braking the basket 200 to stop rotation of the basket 200, as described later.

The housing 100 has a round bottom 101 and a cylindrical side wall 102 on the bottom 101, with a central spike 105 projecting upwardly from the bottom 101. Similarly but slightly smaller in size, the basket 200 has a round bottom 201 and a cylindrical side wall 202 upstanding integrally therefrom. The basket bottom 201 has a central dent 205 which faces downwards and bears upon the spike 105, such that the basket 200 is rotatable about the central axis X. The basket 200 with lid 210 is slightly smaller than the interior of the housing 100 with cover 110, and fits loosely therein.

As to the basket 200, its side wall 202 has a peripheral part 203 at the top, which in turn includes an upwardly-facing circular rim 204. The rim 204 is slightly expanded, with a diameter slightly larger than that of the basket wall 202, whereby a shallow flat cylindrical seat is formed across the top opening of the basket 200, within which shallow flat cylindrical seat, or the rim 204, the lid 210 fits and is located.

The lid 210 and the basket 200 are coupled together for simultaneous rotation through angular inter-engagement between peripheral lugs 219 on lid's lower surface and reinforcement ribs 209 on the basket's inner surface, such that the basket 200 and lid 210 will rotate and stop at the same time.

The housing cover 110 is convex upwardly and the basket lid 210 concave downwardly, together forming between them a circular central cavity in which the drive mechanism 300 is located.

The drive mechanism 300 comprises a lever 310 pivotable in opposite first and second directions, a first ratchet R1 rotatable by the lever 310 pivoting in the first direction, a second ratchet R2 rotatable by the lever 310 pivoting in the second direction, and a train of gears 320 arranged to transmit rotation from the first and second ratchets R1 and R2 in respective opposite first and second directions alternately to the basket 200.

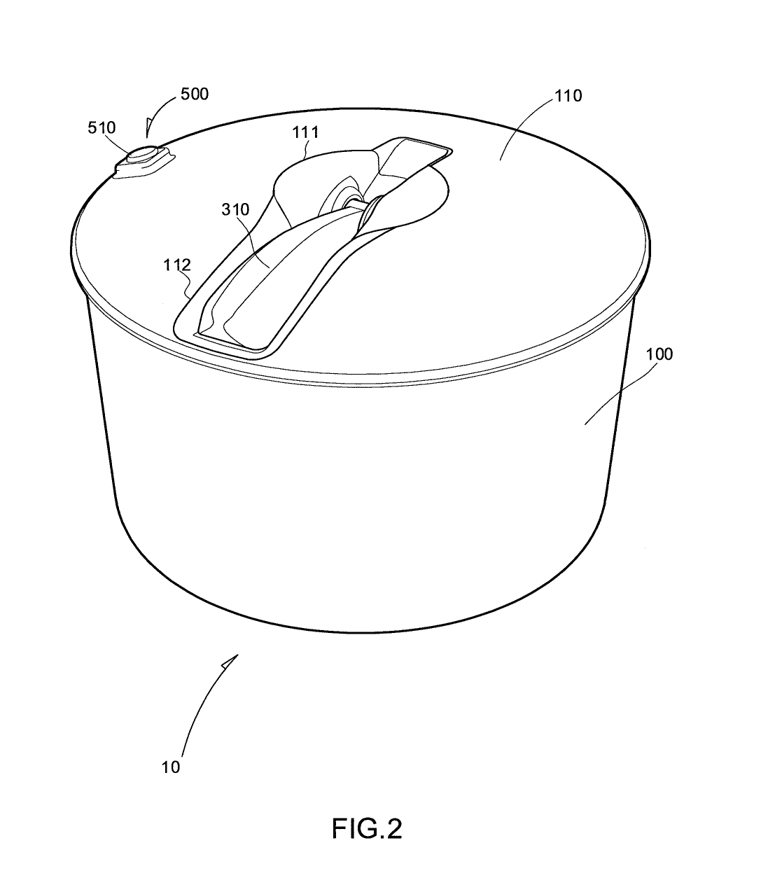

The lever 310 has one end 311 which is pivotably connected in a recessed central region 111 of the housing cover 110 by means of a horizontal axle 330, with the opposite end being free for manual operation. The lever 310 is pivotable upwards and downwards relative to the cover 110 (c.f. FIGS. 1 and 2) for operating the drive mechanism 300. The cover 110 is formed with an oblong recess 112 which encompasses the central region 111 and is shaped to match the lever 310, fully into which recess 112 the lever 310 may be pivoted for storage (FIG. 2).

The hinged lever end 311, that being of a cylindrical shape co-axial with the axle 330, has opposite left and right side surfaces which are each formed with a respective ring of ratchet teeth 311T for rotary ratchet operation to transmit rotational drive in only one direction. The teeth 311T on one said lever end side surface are skewed in opposite angular direction (e.g. clockwise) compared to those on the opposite side surface (i.e. anti-clockwise). There are two said rotary ratchet operations which are to take place alternately, and in opposite angular directions, on opposite left and right sides of the lever 310.

Each of the two ratchet operations also involves the use of a respective square-shaped rotary ratchet member 312 which is disposed on the axle 330 right next to the associated side surface of the lever end 311. The ratchet member 312 is formed with a ring of ratchet teeth 312T facing and co-operable with the ratchet teeth 311T on that side surface. A coil spring 313 is disposed on the axle 330 to hold the two rings of teeth 311T and 312T inter-engaged when they rotate in the drive-transmitting direction, or they slip in the opposite direction.

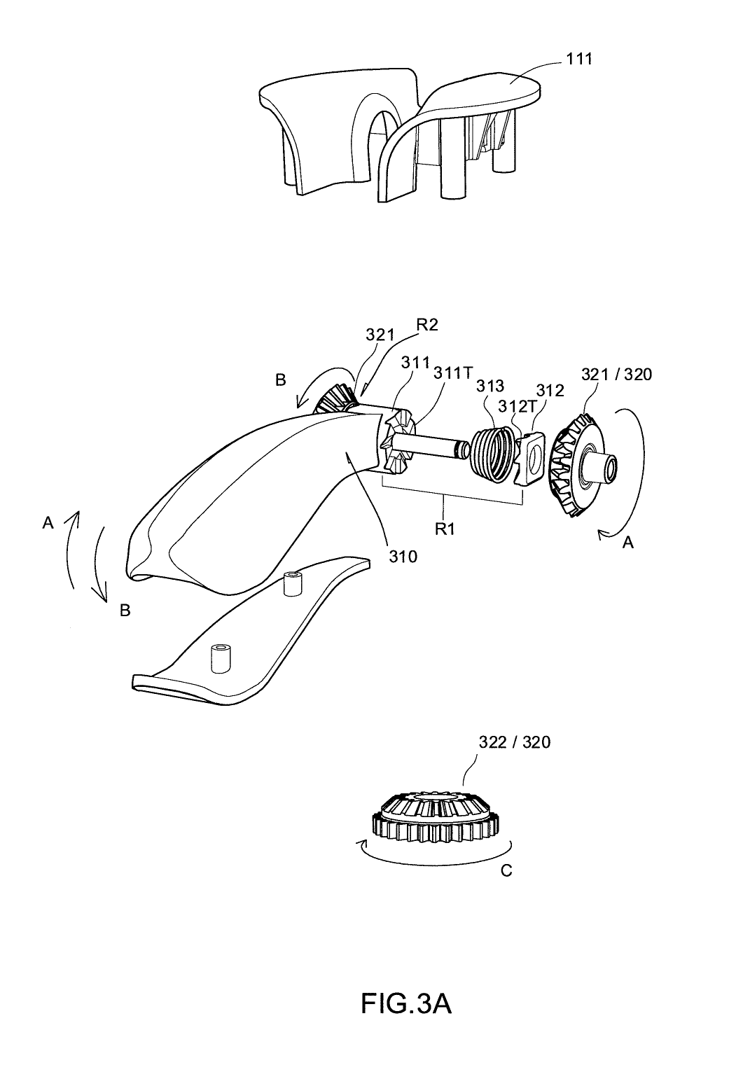

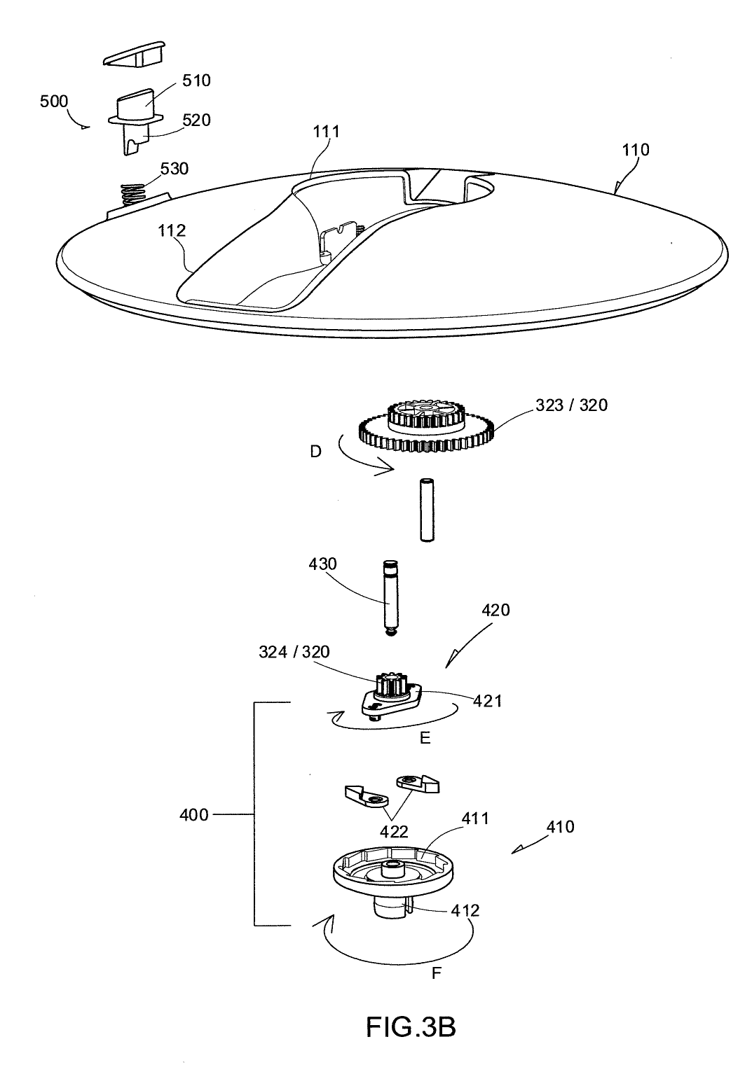

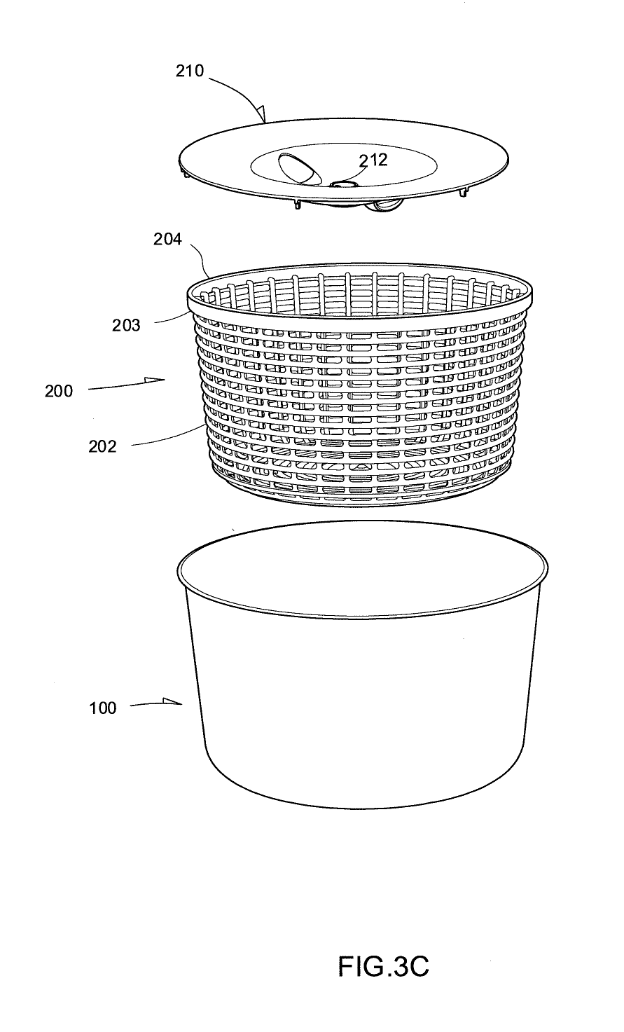

As is apparent from the operation described above, the two ratchet members 312 are co-operable with the left and right side surfaces of the lever end 311 respectively, through interaction between their ratchet teeth 311T and 312T on each side, to implement the first and second ratchets R1 and R2 respectively. As is illustrated in FIG. 3A, the first ratchet R1 will transmit clockwise rotational drive when the lever 310 is pivoted upwards (see arrows A), and the second ratchet R2 will transmit anti-clockwise rotational drive upon the lever 310 being pivoted downwards (see arrows B).

The train of gears 320 is formed, in the sequence of drive, by a pair of bevel gears 321, a compound bevel gear 322, a compound gear 323 and a pinion 324. The pair of bevel gears 321 is disposed on the axle 330, at opposite ends thereof and right next to the ratchet members 312 respectively. Each bevel gear 321 has a square-shaped central recess matching and slidably receiving the respective ratchet member 312 for rotation thereby in the driving direction and to give it room to recede thereby allowing the relevant ratchet R1/R2 to slip in the reverse direction.

Referring again to the illustration in FIG. 3A, the right bevel gear 321 will receive clockwise rotational drive from the first ratchet R1 when the lever 310 is pivoted upwards (see arrows A), and the left bevel gear 321 will receive anti-clockwise rotational drive from the second ratchet R2 upon the lever 310 being pivoted downwards (see arrows B). Overall, the two bevel gears 321 will rotate in opposite directions as the lever 310 is pivoted to reciprocate up and down.

Being located symmetrically right below the two bevel gears 321, the compound bevel gear 322 has its opposite left and right sides in mesh with the bevel gears 321 respectively. Upon the lever 310 being pivoted up and down, as the two bevel gears 321 will turn in opposite directions but they are engaged on opposite sides of the compound bevel gear 322, the compound bevel gear 322 will rotate in one direction (arrow C), in an intermittent yet unidirectional manner.

Via the bevel gears 321, the first and second ratchets R1 and R2 are in drive transmission with the opposite sides of the compound bevel gear 322, and the compound bevel gear 322 is driven by the first and second ratchets R1 and R2 alternately to rotate in one direction for in turn rotating the basket 200. With the use of the compound bevel gear 322, the rotational drive is not only unified in terms of direction but is also turned 90° to be about the central axis X, both for spinning of the basket 200.

The compound gear 323 rotates in one direction (arrow D) and transmits the rotational drive, at an increased speed, to the pinion 324 for rotation in the opposite direction (arrow E). The pinion 324 is part of an accelerator 400 which primarily further increases the speed of the rotational drive to the basket 200.

The accelerator 400 is another ratchet device which is formed by a horizontal flywheel 410 bearing an inner ring of ratchet teeth 411 and by a driver 420 located co-axially within the flywheel 410 for rotating the flywheel 410 in the same direction (arrow F) about a common vertical axis i.e. the central axis X. The flywheel 410 includes a central leg 412 which is split-tubular for drive engagement with and through a central hole 211 in the basket lid 210, for spinning the basket 200.

The driver 420 has a horizontal diamond-shaped plate 421 and a pair of pawls 422 freely hinged at opposite ends of the plate 421 for pivoting outwards and inwards about respective vertical axes. The plate 421 is integrally formed with the pinion 324 atop, by means of which the plate 421 is rotated to swing both of its pawls 422 outwards by virtue of centrifugal action. The flywheel 410 has its ratchet teeth 411 skewed in one direction for engagement by the pawls 422 when the pinion 324 or overall driver 420 rotates in direction E as it always does in operation.

The flywheel 410 and driver 420 are held together by means of a vertical spindle 430 along the central axis X. The spindle 430 mounts the accelerator 400 centrally and co-axially (i.e. about the central axis X) underneath a central hub 115 which is an integral part on the inner side of the housing cover 110. The hub 115 houses most parts of the drive mechanism 300, which are the hinged end 311 of the lever 310, the axle 330 and related components i.e. at least the first and second ratchets R1 and R2, the two bevel gears 321 and the compound bevel gear 322.

The accelerator 400 is supported by the hub 115 centrally underneath the cover 110, with the split-tubular leg 412 of its flywheel 410 projecting downwardly lowermost for engaging or coupling with the lid 210 of the basket 200 placed in the housing 100 when the housing 100 is closed by its cover 110. Inside the housing 100, the basket 200 is normally located in a central position by the spike 105 from below (i.e. the bottom of the housing 100) and the accelerator leg 412 from above.

The rotational drive from the lever 310 is intermittent by nature and will, in practice, reduce down to zero momentarily every time upon the lever 310 changing its pivotal direction at either upper or lower stop position. The accelerator 400 serves to transmit the rotational drive, in an uninterrupted manner and at an increased speed, from the drive mechanism 300 to the basket 200. The basket 200 (particularly when it is loaded with content) represents a significant mass or load to the drive mechanism 300, and will continue to rotate by inertia once the motion is started.

The accelerator 400 operates in this manner. When the lever's rotational drive becomes slower than the basket 200, the driver 420 (related to the former) will fall behind the flywheel 410 (related to the latter). Thus relative to the flywheel 410, the driver 420 becomes rotating backward, whereupon its pawls 422 are pivoted inwards and slipped by the ratchet teeth 411 advancing faster. The basket 200 hence continues to rotate without losing much speed or being hindered by the then slower rotational drive, until the rotational drive re-gains dominance when the lever 310 sufficiently speeds up between the upper and lower stop positions.

In summary, the accelerator 400 is a rotary ratchet device which is operable in one direction to transmit rotational drive from the lever 310 when, or for as long as, the rotational drive is faster than the basket 200 and to release intermittently when the rotational drive is slower than the basket 200. With the use of the accelerator 400, the lever 310 will turn the basket 200 for as long as it is running faster, and will let go intermittently when it is behind.

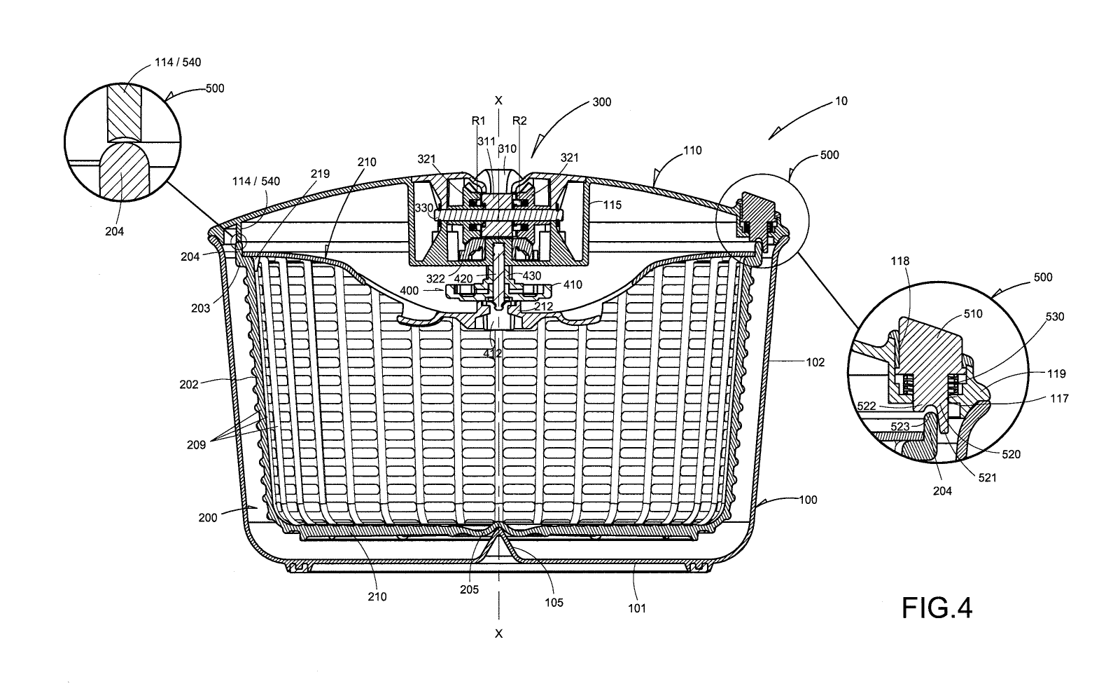

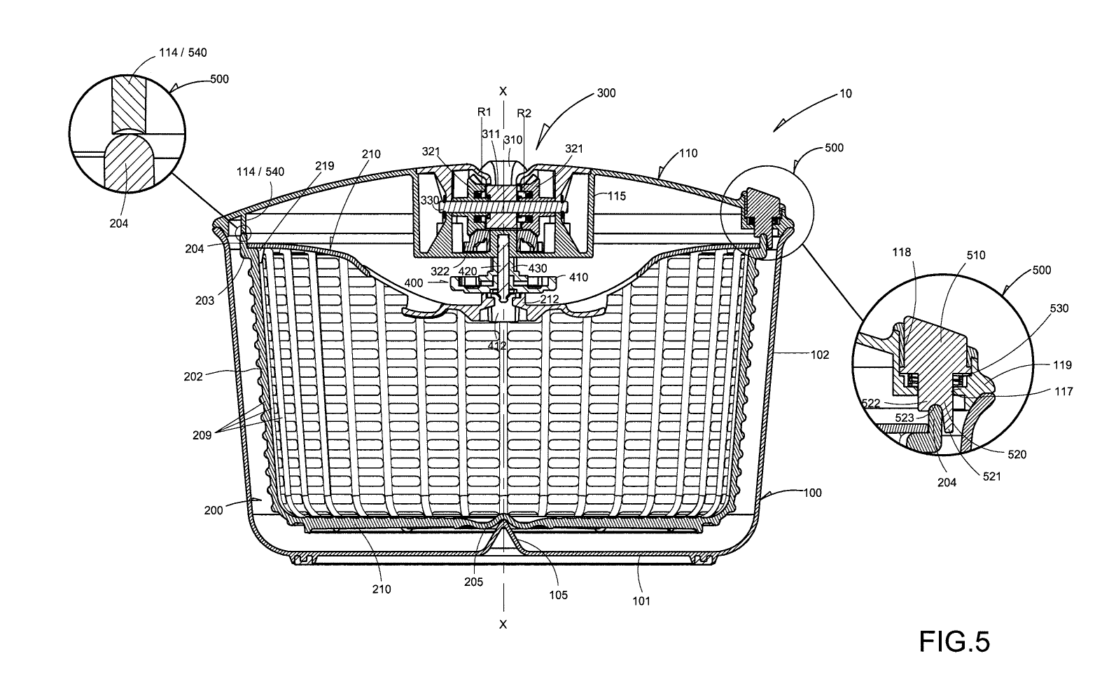

Reference is now made to the brake mechanism 500, which comprises an operator 510 for manual operation to operate the brake mechanism 500 and a braking member 520 movable by the operator 510 from an (upper) inoperative position (FIG. 4) to an (lower) operative position (FIG. 5) into direct engagement with the basket 200 for braking the basket 200 to stop rotation of the basket 200 by friction.

In this particular embodiment, the braking member 520 is arranged in the operative position to directly engage the side wall 202 of the basket 200 for stopping rotation thereof. More specifically, it is a peripheral part 203 of the side wall 202 that is directly engageable by the braking member 510, as in general by being peripheral the peripheral part 203 is relatively farthest away from the axis of rotation X of the basket 200 and therefore comparatively speaking a minimum braking force is required. In particular, the peripheral part 203 is preferred to be the upward-facing rim 204 of the basket's side wall 202.

The housing cover 110 has a peripheral portion or edge 119, at which the brake mechanism 500 is provided, in alignment with the rim 204 of the basket 200. At where the brake mechanism 500 is, the cover 100 is formed with a recess 118 having a bottom hole 117 which reveals a small section of the basket rim 204 below.

The operator 510 and braking member 520 are an integral one-piece structure, with the former being an upper part and the latter a lower part. The operator 510 is received or sits in the recess 118, whilst the braking member 520 extends through the hole 117 for accessing the basket rim 204. The braking member 520 has an upper inoperative position slightly off the rim 204 and a lower operating position directly engaging the rim 204, being in general movable between the upper inoperative position and the lower operative position. The braking member 520 is resiliently biased towards the inoperative position, i.e. upwards, by means of a coil spring 530 in the recess 118 acting upon the bottom of the operator 510.

To operate the braking mechanism 500, the operator 510 acts as a press knob for depression against the action of the spring 530 in order to press the braking member 520 into direct contact with the basket rim 204, thereby applying friction to the rim 204 and hence the basket 200 to stop rotation thereof.

The braking member 520 has a bifurcate lower end for, in the operative position, engaging the rim 204 to brake the basket 200 by riding on or over the rim 204 when viewed in cross-section. The bifurcate lower end comprises a first prong 521 for bearing upon an outer side or surface of the basket rim 204 and a relatively shorter second prong 522 for bearing marginally upon an inner side or surface of the rim 204, with a bend 523 between the prongs 521 and 522 that matches the upper cross-sectional shape of the rim 204 (FIG. 5).

The first prong 521 is sufficiently long to extend downwardly and cross the basket rim 204 from above such that even if there is any minor misalignment the braking member 520 is able to re-align and engage with the rim 204 at the desired position i.e. with its bend 523 right against the top of the rim 204. The second prong 522, that being on the inner side of the rim 204, is made sufficiently short to avoid physical contact with the lid 210 of the basket 200. This is in line with the function of the brake mechanism of the subject invention, which is applying friction to brake the basket through direct engagement with the basket proper.

To assist in the braking of the basket 200, the brake mechanism 500 optionally includes a brake element 540 to provide additional direct engagement with the basket 200 when the braking member 520 is in its operative position. The brake element 540 is provided adjacent, at a small distance apart from, the basket 200 for engagement by the basket 200 when the basket 200 is being engaged by the braking member 520.

As mentioned earlier, the basket 200 is supported loosely in the housing 100 for rotation. Hence the basket 200 will inevitably be displaced, albeit slightly, when the braking member 520 engages and applies a frictional braking force upon the basket 200. It is desirable if such a displacement can be utilized to trigger the use of the brake element 540. Hence, as in the case of the described embodiment, the basket 200 is arranged to be displaced by the braking member 520 into engagement with the brake element 540 for additional friction.

In terms of specific construction, the cover 110 of the housing 100 is formed, on its lower or inner surface, with an integral annular rib or collar 114 which has the same diameter as the rim 204 of the basket 200 and is operatively in alignment with the basket 200 or rim 204, extending co-axially with the basket 200 about the axis of rotation X. The collar 114 is a part of the cover 110 which extends vertically downwardly from the cover's underside, reaching at a small distance short of the rim 204 when the basket 200 is in its normal central position in the housing 100. The collar 114 extends almost 360° around the central axis X, save the recess 118 that locates the operator 510 and braking member 520. The collar 114 provides, as an example of implementation of, the brake element 540.

The height of the collar 114 is determined and the basket 200 is designed to stay in its normal central position during spinning operation, without coming into contact with the collar 114, with the result that the basket 200 is normally free to rotate without hindrance. However, upon braking by the braking member 520 applied upon the rim 204, the basket 200 will be slightly tilted or deformed, or displaced generally stated, such that a part of the (rotating) rim 204, and in particular the part opposite the braking member 520 about the central axis X, will slidingly come into contact with and bear or abut upon a part of the collar 114 at the same position, whereby additional braking is applied to facilitate stopping of the basket 200.

The part of the collar 114 that is most likely engageable by the rim 204 of the displaced basket 200 during braking is at where it is directly or diametrically opposite the braking member 520 about the central axis X, because the basket 200 is likely pivoted by the braking member 520 about the central spike 105 such that the part of its rim 204 farthest away (i.e. directly/diametrically opposite) is tilted uppermost.

Based on this phenomenon, the collar 114 may be replaced by a stationary post or lug depending vertically from the inner surface of the housing cover 110 at a position directly or diametrically opposite the braking member 520 about the central axis X. A plurality of, for example two or three, such posts or lugs may be provided together with the braking member 520 at equiangular positions about the axis of rotation X or around the inner surface of the cover 110 to provide enhanced or balanced braking assistance. Such post(s) or lug(s) is another example of implementation of the brake element 540. As their presence is discrete (i.e. not continuous) compared to the collar 114, the chance or extent of unintended hindrance to the normal spinning of the basket 200 (i.e. being hit by the rim 204) is minimized.

The braking member 540, e.g. the collar 114 or aforesaid post(s) or lug(s), serves additionally or alternatively as an abutment or protrusion which protrudes from the inner surface of the cover 110 and is provided adjacent the basket 200 for bearing by the basket 200 when the basket 200 is being engaged by the braking member 520, thereby maintaining the position of the basket 200 during braking of the basket 200. Such an abutment is provided on at least one side of the spike 105, which supports the basket 200 for rotation, opposite the braking member 520 about the axis of rotation X. The abutment is provided by an inner part of the housing cover 110 and is operatively in alignment with the basket 200 for bearing by the basket 200.

The invention has been given by way of example only, and various other modifications of and/or alterations to the described embodiments may be made by persons skilled in the art without departing from the scope of the invention as specified in the appended claims.

1. A food spinner comprising:
a housing including a cover;
a basket supported in the housing for rotation about an axis of rotation;
a drive mechanism supported by the cover for rotating the basket; and
a brake mechanism supported by the housing for braking the basket and for stopping rotation of the basket, wherein the brake mechanism comprises
an operator for manual operation to operate the brake mechanism, and
a braking member movable by the operator from an inoperative position to an operative position where the braking member is in direct engagement with the basket for braking the basket by friction.

2. The food spinner as claimed in claim 1, wherein
the basket comprises a bottom and a side wall upstanding from the bottom, and
the braking member is arranged in the operative position to directly engage the side wall for stopping rotation of the basket.

3. The food spinner as claimed in claim 2, wherein
the side wall has a peripheral part, and
the braking member is arranged in the operative position to directly engage the peripheral part for stopping rotation of the basket.

4. The food spinner as claimed in claim 3, wherein the peripheral part comprises a rim of the basket, the rim being upwardly-facing.

5. The food spinner as claimed in claim 1, wherein the brake mechanism includes a brake element providing additional direct engagement with the basket when the braking member is in the operative position, thereby assisting in braking of the basket.

6. The food spinner as claimed in claim 5, wherein the brake element is located adjacent the basket for engagement by the basket when the basket is being engaged by the braking member, thereby assisting in braking of the basket.

7. The food spinner as claimed in claim 6, wherein the basket is supported loosely in the housing and is arranged to be displaced by the braking member into engagement with the brake element.

8. The food spinner as claimed in claim 6, wherein
the housing includes a support which supports the basket for rotation, and
the brake element is located on at least one side of the support, opposite the braking member with respect to the axis of rotation.

9. The food spinner as claimed in claim 8, wherein the cover has an inner part which provides the brake element and is operatively in alignment with the basket for engagement with the basket.

10. The food spinner as claimed in claim 1, including an abutment located adjacent the basket, for bearing by the basket, when the basket is being engaged by the braking member, thereby maintaining the position of the basket during braking of the basket.

11. The food spinner as claimed in claim 10, wherein
the housing includes a support which supports the basket for rotation, and
the abutment is located on at least one side of the support, opposite the braking member, with respect to the axis of rotation.

12. The food spinner as claimed in claim 11, wherein the cover has an inner part which provides the abutment and is operatively in alignment with the basket for bearing by the basket.

13. The food spinner as claimed in claim 9, wherein the inner part of the cover is annular and is coaxial with the basket, relative to the axis of rotation.

14. The food spinner as claimed in claim 13, wherein the inner part comprises an annular rib which is coaxial with the basket relative to the axis of rotation.

15. The food spinner as claimed in claim 9, wherein the inner part of the cover comprises at least one protrusion which protrudes from an inner surface of the cover.

16. The food spinner as claimed in claim 15, including a plurality of protrusions, which, together with the braking member, are located at equiangular positions with respect to the axis of rotation.

17. The food spinner as claimed in claim 4, wherein the braking member is movable between an upper inoperative position and a lower operative position, and includes a bifurcated lower end for, in the operative position, engaging the rim of the basket to brake the basket by riding on the rim.

18. The food spinner as claimed in claim 17, wherein the bifurcated lower end has a first prong for bearing upon an outer side or surface of the rim and a relatively shorter second prong for bearing upon an inner side or surface of the rim.

19. The food spinner as claimed in claim 4, including a lid, wherein the basket is closable by the lid which fits within the rim of the basket, the lid being operatively in engagement with the drive mechanism for rotation by the drive mechanism to rotate the basket.

20. The food spinner as claimed in claim 1, including a lid, wherein the basket is closable by the lid and the lid is operatively in engagement with the drive mechanism for rotation by the drive mechanism to rotate the basket.

21. The food spinner as claimed in claim 1, including a spring, wherein the braking member has an upper inoperative position and a lower operating position, and is resiliently biased towards the upper inoperative position by the spring, the operator being moved against biasing action of the spring to operate the brake mechanism.

22. The food spinner as claimed in claim 1, wherein the cover has a peripheral portion, at which the brake mechanism is located.

23. The food spinner as claimed in claim 1, wherein
the drive mechanism comprises
a lever pivotable in opposite first and second directions,
a first ratchet rotatable by the lever pivoting in the first direction,
a second ratchet rotatable by the lever pivoting in the second direction, and
a train of gears arranged to transmit rotational drive from the first and second ratchets in respective opposite first and second directions, alternately, to the basket, wherein the train of gears includes a gear having opposite left and right sides with which the first and second ratchets are in drive transmission, respectively, such that the gear is driven by the first and second ratchets, alternately, to rotate in one direction for rotating the basket.

24. The food spinner as claimed in claim 23, wherein the drive mechanism includes a rotary ratchet device operable in one direction to transmit the rotational drive from the lever, when the rotational drive is faster than rotation of the basket, and to release intermittently, when the rotational drive is slower than rotation of the basket.
